(19) United States
(12) Patent Application Publication
(10) Pub. No.: US 2021/0139214 A1
(43) Pub. Date: May 13, 2021

(54) STORAGE SYSTEMS FOR PERSONAL HYGIENE PRODUCTS

(71) Applicant: John Lample, Libertyville, IL (US)

(72) Inventor: John Lample, Libertyville, IL (US)

(21) Appl. No.: 17/096,827

(22) Filed: Nov. 12, 2020

Related U.S. Application Data
(60) Provisional application No. 62/934,374, filed on Nov. 12, 2019.

(51) Int. Cl. B65D 65/10

(52) U.S. Cl. CPC B65D 65/10; A46B 17/00

(57) ABSTRACT

Systems for storage of personal hygiene products, such as toothbrushes and shaving devices, are provided. The systems, such as covers for personal care products, provide water and gas permeable storage vessels that are substantially impermeable to microorganisms. The storage systems wick moisture away from enclosed products while providing protection from microbial contamination.

### CROSS-REFERENCE TO RELATED APPLICATION

This application claims benefit of the filing date and right of priority to U.S. Provisional Application No. 62/934,374, filed Nov. 12, 2019, which is incorporated by reference herein.

### FIELD OF THE INVENTION

The invention relates to systems for storage of personal hygiene products, including, but not limited to, toothbrushes. The systems described herein provide product covers or enclosures that are water and gas permeable while being substantially impermeable to microorganisms. Thus, the systems described herein solve problems related to storage of hygiene products by wicking moisture away from enclosed products and providing a barrier to microbial contamination.

### BACKGROUND OF THE INVENTION

Storage of personal hygiene products in a manner that prevents contamination of the product is an important and challenging unmet need. Personal hygiene products, such as toothbrushes, that are stored without a case often become contaminated with microorganisms. (See, for example, J Nat Sci Biol Med. 2015 August; 6 (Suppl 1): S44-S48 and Int J Oral Health Sci 2019; 9:25-7.) This contamination is exacerbated, for products stored in a bathroom, by toilet flushing which tends to aerosolize microbes in the bathroom environment. Furthermore, storage of toothbrushes during travel is needed to protect the bristles from contamination with dirt, dust, and microbes. Accordingly, cases for storage of toothbrushes have been created to address these issues.

However, currently available cases, including toothbrush covers, may protect products from aerosolized microbes, but they create other unintended consequences that are potentially worse than the contamination issues they are intended to address. Specifically, currently available toothbrush cases are impermeable to water and, therefore, create a dark, warm, and moist environment that is rich with nutrients from food particles. This environment is ideal for microbial proliferation. Therefore, toothbrushes that are stored in conventional cases typically exhibit a higher microbial load than toothbrushes that are stored uncovered, thus worsening the problem they are designed to address. (See, for example, Journal of dental hygiene: JDH/American Dental Hygienists' Association 78:19-19 and https://www.mentalfloss.com/article/56671/11-gross-things-could-be-your-toothbrush.) Indeed, the American Dental Association (ADA) does not recommend storage of toothbrushes in the currently available cases. (See, for example, https://www.ada.org/en/member-center/oral-health-topics/toothbrushes.) Instead, the ADA recommends storing toothbrushes uncovered and upright to promote drying of the bristles, but this does not provide protection of the bristles from contamination, particularly in a bathroom or travel setting.

Thus, there remains a need for a suitable personal hygiene product storage system that protects stored items from environmental contamination (dirt, dust, microbes, aerosolized materials, etc.) without providing a breeding ground for microbial expansion. A suitable storage system needs to be water and gas permeable so that the enclosed personal hygiene product will dry due to wicking, dissipation and/or evaporation of moisture. The suitable storage system also needs to be substantially impermeable to microorganisms so that contamination of the enclosed product is avoided.

### SUMMARY OF THE INVENTION

In one aspect, the present technology is related to a system for storage of personal hygiene products, wherein the system provides a cover for such personal hygiene products. The cover is made from a gas and water permeable material which is substantially impermeable to one or more microorganisms. The cover can be formed from a material having pores smaller than the microorganisms from which the personal hygiene products are protected.

In some embodiments, the system prevents contamination of products stored therein. In other embodiments, the system prevents contamination from aerosolized microorganisms generated by flushing a toilet. In some embodiments, the microorganism is a germ or virus.

In some embodiments, the system promotes fast drying of enclosed personal hygiene products, such as moist toothbrushes, through wicking, equilibration, dissipation, and evaporation of water through the water permeable material. Accordingly, the storage systems of the present technology promote drying of enclosed products regardless of the orientation of the storage system (horizontal, vertical, upright, etc.). The storage systems of the current technology function equally well when positioned in any orientation as desired by the user. This provides advantages and convenience for storage, particularly during travel. This feature of the present system provides additional advantages over uncovered toothbrushes, because uncovered toothbrushes must be stored in an upright, vertical orientation to promote drying, as recommended by the ADA. This upright orientation is not a requirement for proper performance of the present storage systems.

In other embodiments, the gas and water permeable material that is substantially impermeable to microorganisms is a cellulose based material. In some embodiments, the cellulose based material is a paper layer comprising viscose, such as by being coated or impregnated with viscose. Viscose can be obtained by treating cellulose with sodium hydroxide or other strong base, following by treatment with carbon disulfide to give a xanthate derivative. The xanthate is then converted back to a cellulose fiber in a subsequent step. In some embodiments, the paper layer is obtained by regular papermaking, comprising only cellulose fibers, before a viscose material or other modified cellulose material is applied. In some embodiments, the gas and water permeable material that is substantially impermeable to microorganisms further comprises an antimicrobial agent, such as by being coated or impregnated with the antimicrobial agent. In other embodiments, the cellulose based material is tubular extruded cellulose. For instance, cellulose fibers from plants can be processed into a pulp and then extruded in a manner similar to extrusion of synthetic fibers like polyester or nylon.

In other embodiments, the gas and water permeable material that is substantially impermeable to microorganisms is a polymer or collagen material, which can be extruded in a tubular format or in the case of polymer it can also be in a flat film. The flat film material is then formed into the final package. In some embodiments, the gas and water permeable material that is substantially impermeable to microorganisms further comprises an antimicrobial agent.

In some embodiments, the system described herein is a case or cover for an oral hygiene device. In some embodiments, the oral hygiene device is a toothbrush. In other embodiments, the storage system provided herein is a reusable toothbrush covering. In some embodiments, the reusable tooth brush cover is a tubular toothbrush cover that encases an entire tooth brush head and handle. In some embodiments, the reusable toothbrush cover is adapted to cover just the tooth brush head.

In other embodiments, the system provided herein is adapted for storing a shaving device.

In some embodiments, the storage system described herein in made from a gas and water permeable material that is substantially impermeable to microorganisms. In some embodiments, the gas and water permeable material that is substantially impermeable to microorganisms is a pliable material. In some embodiments, the gas and water permeable material that is substantially impermeable to microorganisms is a regenerated extruded cellulose material. In some embodiments, the system is made from and/or also includes a paper material coated with cellulose, or an extruded tubular polymer, or extruded collagen.

In some embodiments, at least one end of the storage system described herein can be opened and closed. In some embodiments, the system can be opened and closed by folding and unfolding at least one end of the system. In some embodiments, the system comprises a clip, a zipper or other mechanism for opening and closing the cover. The closing mechanism can be integral with the cover, or it may be a separate piece (e.g., a clip that is not attached to the cover when not in use). In some embodiments, the system includes a stainless-steel tie clip for opening and closing at least one end.

These and other features and advantages of the present methods and apparatus will be apparent from the following detailed description, in conjunction with the appended claims.

### BRIEF DESCRIPTION OF THE DRAWINGS

The present teachings are best understood from the following detailed description when read with the accompanying drawing figures. The features are not necessarily drawn to scale. Wherever practical, like reference numerals refer to like features.

FIG. 1 is a schematic illustration demonstrating the selective permeability of certain materials of the present technology.

FIG. 2 includes a photograph of an embodiment of the present technology and a schematic of a system comprising a closable end.

FIG. 3 is a schematic representation of how certain cellulose based materials of the present technology can be produced.

FIG. 4 is a schematic representation of how certain polymer based materials of the present technology can be produced.

FIG. 5 includes a photograph of an embodiment of the present technology.

FIG. 6 is a photograph displaying the morphology of a suitable material for the present systems.

### DETAILED DESCRIPTION OF THE INVENTION

It is to be understood that the terminology used herein is for purposes of describing particular embodiments only, and is not intended to be limiting. The defined terms are in addition to the technical and scientific meanings of the defined terms as commonly understood and accepted in the technical field of the present teachings.

### Definitions

As used herein, and in addition to their ordinary meanings, the terms “substantial” or “substantially” mean to within acceptable limits or degree to one having ordinary skill in the art.

As used herein, the terms “approximately” and “about” mean to within an acceptable limit or amount to one having ordinary skill in the art. The term “about” generally refers to plus or minus 15% of the indicated number. For example, “about 10” may indicate a range of 8.5 to 11.5. For example, “approximately the same” means that one of ordinary skill in the art considers the items being compared to be the same. In the present disclosure, numeric ranges are inclusive of the numbers defining the range.

As used herein, the term “personal hygiene products” refers to any device or product used by an individual for hygienic purposes, including but not limited to, oral hygiene products and shaving products.

As used herein, the term “cover” or “case” refers to an appropriately sized and shaped vessel, container, or the like, constructed in whole or in part of a material of the present technology to fit over and/or around, or otherwise enclose, in whole or in part, a personal hygiene product. Exemplary covers of the present technology are pictured in FIGS. 2 and 5.

As used herein, the term “water permeable material” refers to a material having a pore size large enough to allow H₂O molecules to pass.

As used herein, the term “gas permeable material” refers to a material having a pore size large enough to allow gas molecules (such as O₂, CO₂, N₂) to pass.

As used herein, the term “substantially impermeable to one or more microorganisms” refers to a material having a pore size that is too small to allow one or more microorganisms, such as E. coli (Escherichia coli) and Listeria monocytogenes, to pass. In other words, a material that is substantially impermeable to microorganisms provides a barrier that does not allow passage of microbes. In some embodiments, a material may be substantially impermeable to a selected set of microbes, such as a group of bacteria or viruses known or suspected to present a higher risk.

As used herein, “pore size” refers to a maximum pore dimension measured or identified for a material, such that particles larger than the pore size will generally be blocked. The material may have smaller pores as well. Some materials may have a limited or negligible number of pores that are larger than the pore size indicated by a manufacturer so long as the number of such pores is not significant.

As used herein, the term “contamination” refers to making something unclean or unusable through contact with something unclean. In particular, contamination as used herein relates to a personal hygiene product becoming unclean through contact with dirt, dust, microorganisms, or the like.

As used herein, the term “microorganism” refers to any germ, virus or microbe such as, but not limited to E. coli (Escherichia coli) and Listeria monocytogenes.

As used herein, the term “cellulose based material” refers to a material comprising or derived from cellulose, a polysaccharide comprising linear chains of several hundred to many thousands of β(1→4) linked D-glucose units. An example of a cellulose based material is a regenerated cellulosic material comprising a fibrous structure such as paper, cotton, wood, or the like. Cellulose based materials included chemically modified cellulosic material, such has materials chemically modified to add functional groups for desired properties.

As used herein, the term “viscose” refers to a prepared solution of cellulose fibers, such as solutions used in the preparation of cellophane, rayon, or the like.

As used herein, the term “polymer” refers to a compound of high molecular weight derived either by the addition of many smaller molecules, as polyethylene, or by the condensation of many smaller molecules with the elimination of water, alcohol, or the like, as nylon.

As used herein, the term “collagen” refers to a compound produced from extracellular proteins abundant in the connective tissues of higher animals. Collagen includes material derived from natural sources as well as recombinant or synthetic collagen.

As used herein, the term “antimicrobial” refers to any agent that destroys or inhibits the growth of microorganisms.

Before the various embodiments are described, it is to be understood that the teachings of this disclosure are not limited to the particular embodiments described, and as such can, of course, vary. It is also to be understood that the terminology used herein is for the purpose of describing particular embodiments only, and is not intended to be limiting, since the scope of the present teachings will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present teachings, some exemplary methods and materials are now described. All patents, publications and websites referred to herein are expressly incorporated by reference.

As used in the specification and appended claims, the terms “a,” “an,” and “the” include both singular and plural referents, unless the context clearly dictates otherwise.

### Water and Gas Permeable/Microorganism Impermeable Materials

The systems of the present technology are made from materials that are breathable and allow wicking and evaporation of moisture from enclosed products while protecting the products from contamination. Accordingly, the materials must possess differential permeability with respect to water and gas when compared to microorganisms. Specifically, water and gas must be able to diffuse through the materials while microorganisms are blocked. Therefore, the materials of the present technology must comprise pores that are large enough for water and gas molecules to move through but that are not so big as to allow microorganisms to pass (FIG. 1).

FIG. 1 is a schematic illustration demonstrating the selective permeability of certain materials of the present technology. Specifically, the storage systems of the present technology are made from a material 101, comprising pores 102 that are permeable to small molecules 103, such as air and water, but substantially impermeable to microorganisms 104. In FIG. 1, “feed” refers to the extrinsic environment containing all molecules the material may come in contact with, while “filtrate” refers to molecules that have diffused through the material. The filtrate can pass in either direction through the material.

In some embodiments the system is adapted to block up to 100% of microorganisms such as Listeria, for example, the system is adapted to block 95% of microorganisms from passing through the cover, or to block 98% or 99% or 100% of microorganisms. The cover's capability for blocking of microorganisms can be assessed by applying a microorganism to only one side of the material and testing for the presence of the microorganism on the opposite side. Example 1 below describes a suitable protocol for such assessment.

FIG. 2A includes a photograph of an embodiment of the present technology. Specifically, a toothbrush cover constructed from a viscose coated paper material 201 that is water and gas permeable, but substantially impermeable to microorganisms, is shown. The pictured cover provides a generally tubular shaped vessel for containing an entire toothbrush head 202 and handle (not visible) and the cover can be closed by folding the material at the ends 203. FIG. 2B includes a schematic of the closable end 203 that further includes a closing means 204 that does not require folding. For example, the closing means 204 can be any feature for opening and/or closing the storage system, such as a re-sealable adhesive strip, clip, zipper, tie, drawstring, etc. In some embodiments, the system includes a closing means 204 that is a stainless-steel tie clip for opening and closing at least one end.

FIG. 5 is a photograph of another embodiment of the present technology. Specifically, a toothbrush cover is constructed from a polymer extruded then converted to a zip bag material 501. The extruded polymer is water and gas permeable, but substantially impermeable to microorganisms, due to its pore size being below a desired cutoff. The pictured cover provides a generally tubular shaped vessel for containing an entire toothbrush head and handle (not shown) that can be closed by zipper locking the material at the end 503. Other closing mechanisms can be used in place of the zipper 503, such as a re-sealable adhesive strip, clip, tie, drawstring, or other.

Examples of breathable structures for materials include woven webs, nonwoven webs, composite materials such as film-coated nonwoven webs, and microporous films.

Gas molecules, such as oxygen (O₂) and nitrogen (N₂), are estimated to have diameters of about 292 and 300 picometers, respectively. A water molecule (H₂O) is estimated to have a diameter of about 275 picometers. Microorganisms, such as E. coli and L. monocytogenes, are much larger and have been measured to have diameters of approximately 1.0 micrometer. Other microorganisms have larger or smaller diameters.

Other microorganisms that are typically found in sinks and bathrooms include Streptococcus bacteria (such as Streptococcus mutans), Pseudomonas bacteria (such as Pseudomonas aeruginosa (P. aeruginosa), Klebsiella bacteria, Candida fungi (such as Candida albicans), and Lactobacillus. bacteria (such as L. deibrueckii). Streptococcus mutans are spherical (0.5-0.75 μm in diameter), gram-positive cocci in pairs or chains. Long chains form in broth and short rod-shaped cells (0.5-1.0 μm in length) can be detected in acidic broth and on some solid media. Pseudomonas aeruginosa is a gram-negative, rod-shaped, asporogenous, and monoflagellated bacterium that has an incredible nutritional versatility. it is a rod about 1-5 μm long and 0.5-1.0 μm wide. Klebsiella has a rod-shaped morphology and may be found singly and in pairs or short chains, with a size of about 0.3-1.0 micrometers by 0.6-6.0 micrometers. Candida albicans can take on either a unicellular (yeast) or multicellular (hyphae, pseudohyphae) form. The yeast form is about 10-12 microns across and is Gram-positive. Lactobacillus are generally nonmotile and can survive in both aerobic and anaerobic environments, L. delbrueckii is about 0.5 to 0.8 micrometer across by 2 to 9 μm long and occurs singly or in small chains. E. coli is a rod-shaped Gram-negative bacterium measuring approximately 0.5 μm in width by 2 μm in length.

Virus particles are generally smaller than bacteria and are more easily aerosolized. For example, SARS-CoV-2 virus particles have been found to have a diameter ranging between 60 nanometers (nm) to a maximum diameter of 140 nanometers (nm). More generally, the majority of identified viruses range in diameter size from 20 nm to as large as 500 nm.

Accordingly, the materials of the present technology comprise pores that are bigger than 300 picometers but smaller than 1 micrometer (μm). Alternatively, the materials comprise pores smaller than 2 μm, or smaller than 5 82 m. This allows the systems of the present technology to promote drying of enclosed products while preventing microbial contamination (See FIG. 1). For example, materials that may be used in the storage systems of the present technology may comprise pores having a diameter of about 300 picometers, about 400 picometers, about 500 picometers, about 600 picometers, about 700 picometers, about 800 picometers, about 900 picometers, about 1 nanometer, about 10 nanometers, about 20 nanometers, about 30 nanometers, about 40 nanometers, about 50 nanometers, about 60 nanometers, about 70 nanometers, about 80 nanometers, about 90 nanometers, about 100 nanometers, about 200 nanometers, about 300 nanometers, about 400 nanometers, about 500 nanometers, about 600 nanometers, about 700 nanometers, about 800 nanometers, about 900 nanometers, about 1 μm, about 1.1 μm, about 1.2 μm, about 1.5 μm, about 2 μm, about 2.5 μm, about 3 μm, about 4 μm, about 4.5 μm, about 4.8 μm, about 4.9 μm, about 5 μm, or any other diameter size in this range. It is contemplated that any two of the foregoing diameters may be combined to provide a desirable range.

The covers used in the present system can have any desired thickness. For example, the cover may have a thickness of at least 5 μm, or 10 μm, or 15 μm, or 20 μm, the cover can have a thickness of at most 500 μm, or 250 μm, or 100 μm, or 75 μm, or 60 μm. Any two of those thickness values can be combined to form a desired range.

The microorganism blocking materials of the present technology possess various water permeabilities as expressed by water vapor barrier values. A water vapor barrier value corresponds to the grams (g) of water that diffuses through one square meter (m²) of material in one day (d). Materials of the present technology typically exhibit a water vapor barrier value of 500-1500 (g/m²*d) when measured at 23 degrees Celsius and an 85% relative humidity in accordance with measuring standard ISO 15106-3. Accordingly, the microorganism blocking materials of the present technology may exhibit a water vapor barrier value of about 500, about 600, about 700, about 800, about 900, about 1,000, about 1,100, about 1,200, about 1,300, about 1,400, or about 1,500 (g/m²*d). It is contemplated that any two of the foregoing values may be combined to provide a desirable range.

The microorganism blocking materials of the present technology possess various gas permeabilities as can be expressed by oxygen barrier values. An oxygen barrier value corresponds to the cubic centimeters (cm³) of oxygen gas that diffuses through one square meter (m²) of material in one day (d) at atmospheric pressure (bar). Materials of the present technology typically exhibit an oxygen barrier value of 20-50 (cm³/m²*d*bar) when measured at 23 degrees Celsius and an 53% relative humidity in accordance with measuring standard DIN 53380. Accordingly, the microorganism blocking materials of the present technology may exhibit an oxygen barrier value of about 20, about 30, about 40, or about 50 (cm³/m²*d*bar). It is contemplated that any two of the foregoing values may be combined to provide a desirable range.

The present systems promote fast drying of a personal hygiene product stored therein. For instance, the system may be configured so that the stored product (for example, a toothbrush) is substantially dry within 30 minutes, or within 1 hour, or within 2 hours, or within 4 hours, or within 6 hours, or within 8 hours, or within 12 hours, after being placed in storage. The dryness of the product can be assessed by a formal analysis or by user's touch. In some embodiments, the stored product dries substantially as quickly as an uncovered or exposed product, in that the cover does not interfere with drying.

### Fibrous Cellulose Materials

In some embodiments, the systems of the present technology are made from cellulose based materials. In some embodiments, the cellulose based materials are produced from renewable raw materials. These materials include regenerated cellulose viscose. In some embodiments the materials are paper that has been coated or impregnated with regenerated cellulose. In some embodiments, viscose or another soluble cellulose based material is extruded as a tubular film through an annular die into coagulating and regenerating baths to produce a tube of regenerated cellulose. The tube is subsequently washed, plasticized and dried. The film may be non-reinforced or reinforced with fibers such as paper. A schematic representation demonstrating how certain cellulose based materials of the present technology are produced is provided in FIG. 3.

FIG. 3 shows a paper layer 302 being unwound from a spool and fed to an extrusion device 304. The paper layer 302 is coated with viscose from a viscose source 306, which can receive sodium cellulose from a feed tank 302, which was fed cellulose from another feed tank 310. The paper layer 302 with viscose is passed to a spinning bath 312, then to various processing tanks, such as a regeneration section 314, a washing section 316, and a refinement section 318. From there, the material can be impregnated in an impregnation section 320. The material is then dried such as by passing through squeezing rolls 312, 326 and a hot air dryer 324. The material is measured by a caliber measurement device 328. After drying, the material can be wound on a reel 330 for storage or to await converting 332 to the finished specifications, such as sizing of the tubing. The material can be subjected to quality assurance testing, such as according to DIN-EN 1509001. The material is then ready for an end user 334. The cellulose based materials of the present technology comprise a web of cellulose fibers.

This web creates pores of the appropriate size (e.g., larger than 300 picometers, but smaller than 1 micrometer, alternatively smaller than 2 μm, or smaller than 5 μm) to allow gas and water diffusion while blocking microorganisms from passing.

In some embodiments, the web of fibers is present in a paper or paper like layer. In other embodiments, the paper or paper like layer comprises a web of cellulose fibers and is coated or impregnated with regenerated cellulose such as viscose. In some embodiments, for example, a porous material of the present technology, that may be used to produce a cover for a personal hygiene product, is a paper material, such as a tea bag paper, that has been coated and/or impregnated with viscose. The viscose may be applied in an amount sufficient to provide a combined material having the desired pore size. In some embodiments deploying fibrous cellulose materials, the cover or enclosure may take the form of a flexible bag-like enclosure, where a hygiene product may be placed therein and sealed via a separate or integrated mechanical fastener or sealing mechanism, re-sealable adhesive, etc.

In some embodiments, a cover comprising paper and a cellulose based material applied to the paper (such as viscose) has a combined weight of at least 1 g/m2, or at least 4 g/m2, or at least 12 g/m2, or at least 20 g/m2, or at least 24 g/m2; or at most 200 g/m2, or at most 120 g/m2, or at most 105 g/m2, or at most 90 g/m2, or at most 75 g/m2, or at most 60 g/m2. Any two of those weight values can be combined to form a range. The cover can comprise at least 10% paper, or at least 25% paper, or at least 50% paper, or at least 75% paper, or at least 90% paper, and/or at least 10% viscose, or at least 25% viscose, or at least 50% viscose, or at least 75% viscose, or at least 90% viscose (subject to the combined percentages totaling 100%, or less if other components are present). In some embodiments, the cover comprises about 50% paper and about 50% viscose. The percentages can be calculated on a weight basis.

### Polymeric Materials

In some embodiments, the systems of the present technology are made from polymeric based materials. For example, in some embodiments, the material is a polyethylene polymer, a polypropylene polymer, or a copolymer of ethylene and propylene. In some embodiments, the polymer is a hydrophilic polymer, or a hydrophobic polymer that is treated to render it water permeable. The polymer based materials of the present technology comprise pores of appropriate sizes (e.g., larger than 300 picometers, but smaller than 1 micrometer, alternatively smaller than 2 μm, or smaller than 5 μm) to allow gas and water diffusion while blocking microorganisms from passing. Various polymer based technologies can be used to prepare polymers comprising appropriately sized pores for use in the systems of the present technology. For example, blending of polymers and additives can be manipulated to modify the properties, including pore sizes, of a polymer and achieve homogeneous polymer mixture for preparation of the materials used in the storage systems of the present technology. An example of a suitable polymer material is a polyethylene separator for lithium batteries, available from ENTEK, Lebanon, Oreg.

A schematic representation demonstrating how certain polymer based materials of the present technology are produced is provided in FIG. 4. The schematic of FIG. 4 exemplifies a tubular extrusion technology wherein polymer based materials may be produced in the shape of a tube. The polymer based materials of the present technology can also be extruded as a film which can be cut and sealed together to create a cover (such as a bag, case, or other vessel/container) for personal hygiene products.

In an extruder 401, a polymer granulate is melted and extruded. The material passes to a tubular die 402 for forming of the polymer melt. A stretch bubble 403 is formed in order to build the tubular film and provide calibration and biaxial orientation. The material passes to a flatness unit 404 for fixation, followed by rewinding 405. The material is then subjected to converting 406, to the final specifications of the product. The polymer based materials of the present technology can also be extruded as a film which can be cut and sealed together to create a bag, case, cover or other vessel/container for personal hygiene products. The polymer based materials of the present technology may also be formed, molded, injection molded, laminated or vacuum formed into any variety of shapes as desired for production of a case or cover for a personal hygiene product. The polymer based materials of the present technology, and the cases/covers made with the polymers, may be rigid, semi-rigid, flexible or semi-flexible as desired for production of specific personal hygiene covers and/or cases.

In some embodiments, for example, a porous material of the present technology, that may be used to produce a cover for a personal hygiene product, is a polymer material, such as a polyethylene film, that has been prepared with appropriate blending and additives to contain pores of the appropriate size (e.g., larger than 300 picometers, but smaller than 1 micrometer, alternatively smaller than 2 μm, or smaller than 5 μm). In some embodiments deploying polymeric materials, the cover or enclosure may take the form of a flexible bag-like enclosure, where a hygiene product may be placed therein and sealed via a separate or integrated mechanical fastener or sealing mechanism, re-sealable adhesive, etc.

In some embodiments, an ultra-high density polyethylene (UHDPE) material is used for the present systems. A UHDPE material or other polyolefin can be produced using a wet process, or by a dry process. The molecular weight distribution of polyethylene or other polymer, the percentage and type of plasticizer, extraction and drying conditions, biaxial stretch ratios, and annealing temperature are all factors that can be selected to determine the final structure and properties of the material. The material is customizable based on key characteristics such as thickness, air permeability, and % porosity.

In some embodiments, the material is a polyolefin having a porosity of 35% to 55%, or 40% to 50%.

FIG. 6 is a photomicrograph displaying the morphology of this specific film showing the pore structure of the film.

### Antimicrobial Agents

In some embodiments, the materials of the present technology, in addition to being water and gas permeable and substantially impermeable to microorganisms, may further include an anti-microbial agent. An antimicrobial agent may be present on the inside layer, outside layer or throughout the material used to produce the storage system. In a particular embodiment, the anti-microbial agent is present on the inside of the storage system in order to eliminate microorganisms that are present on products, such as used toothbrushes, stored inside the systems of the present technology.

An antimicrobial agent of the present technology is an agent that kills microorganisms or inhibits their growth. Antimicrobial agents can be grouped according to the microorganisms they act primarily against. Antimicrobial agents are of various classes, some of the class includes: beta lactam, cephalosporins, quinolones, tetracyclines, macrolides, sulfonamides, aminoglycosides, etc. Antimicrobial agents include antibiotics, antiseptics, and disinfectants. Antiseptic agents include quaternary ammonium salts such as benzalkonium chloride, cetylpyridinium chloride, and cetrimide; metals and metal ions such as silver, copper, copper alloys; chlorhexidine and salts thereof (such as chlorhexidine gluconate or chlorhexidine acetate); phenols such as phenol itself, triclosan, hexachlorophene, chlorocresol, and chloroxylenol; quinolines such as hydroxyquinolone, dequalium chloride, and chlorquinaldol; alcohols such as ethanol and 2-propanol/isopropanol; peroxides such as hydrogen peroxide and benzoyl peroxide; iodines such as povidone-iodine; and others. These different classes act in a different way and on different kinds of bacteria. It is envisioned that different anti-microbial agents, and/or combinations thereof, may be used in the materials of the storage systems of the present technology in order to target the specific microbe most relevant to the stored product, such as E. coli and L. monocytogenes. In some embodiments, the systems comprise an antimicrobial agent that kills or inhibits one or more of Streptococcus (such as Streptococcus mutans), Pseudomonas (such as Pseudomonas aeruginosa), Klebsiella, Candida (such as Candida albicans), and/or Lactobacillus (such as L. delbrueckii).

In some embodiments, one or more antimicrobial agents is bonded to the surface of the cover, such as an inner surface, an outer surface, or both. In some embodiments, one or more antimicrobial agents are adsorbed or embedded within the interior or thickness of the cover.

### Methods of Producing a Cover for a Personal Hygiene Product

As another aspect of the present invention, methods of producing a cover for a personal hygiene product are provided. The method can include extruding a material to form a layer that is permeable to gas and water permeable and substantially impermeable to one or more microorganisms; and forming a closeable tube from the extruded layer. In some embodiments, the tube is formed by cutting and sealing edges of the layer together. The method can also include forming a re-sealable closing mechanism on the tube. In some embodiments, the extrusion step(s) are performed so as to form pores as described herein, for example, the extrusion can be conducted to form a layer having pores that are bigger than 300 picometers but smaller than 1 μm, or smaller than 2 μm, or smaller than 5 μm. In some embodiments, the method comprises prepared or obtaining a regenerated cellulose having desired properties. In some embodiments, the method comprises extruding viscose or another a soluble cellulose based material as a tubular film through an annular die, followed by treating in one or more solutions to produce a tube of regenerated cellulose. In some embodiments, the method comprises applying viscose as a liquid to paper, such as by coating and/or impregnating.

### EXEMPLARY EMBODIMENTS

Embodiment 1. A system for storage of personal hygiene products,
wherein the system provides a cover for said personal hygiene products;
wherein said cover is made from a gas and water permeable material; and
wherein the gas and water permeable material is substantially impermeable to microorganisms.

Embodiment 2. The system of embodiment 1, wherein the system prevents contamination of products stored therein.

Embodiment 3. The system of embodiment 1 or 2, wherein the system promotes drying of enclosed products through wicking and evaporation of moisture.

Embodiment 4. The system of any of embodiments 1-3, wherein a source of prevented contamination is aerosolized microorganisms generated by flushing a toilet.

Embodiment 5. The system of any of embodiments 1-4, wherein the microorganism is a germ or virus.

Embodiment 6. The system of any of embodiments 1-5, wherein the gas and water permeable material that is substantially impermeable to microorganisms is a cellulose based material.

Embodiment 7. The system of embodiment 6, wherein the cellulose based material is a paper layer comprising viscose.

Embodiment 8. The system of embodiment 6, wherein the cellulose based material is extruded cellulose.

Embodiment 9. The system of any of embodiments 1-8, wherein the gas and water permeable material that is substantially impermeable to microorganisms further comprises an antimicrobial agent.

Embodiment 10. The system of any of embodiments 1-9, wherein the personal hygiene product is an oral hygiene device.

Embodiment 11. The system of embodiment 10, wherein the oral hygiene device is a toothbrush.

Embodiment 12. The system of embodiment 11, wherein the system is a reusable tooth brush covering.

Embodiment 13. The system of embodiment 12, wherein the reusable tooth brush covering is a tubular tooth brush cover that encases an entire tooth brush head and handle.

Embodiment 14. The system of any of embodiments 1-9, wherein the personal hygiene product is a shaving device.

Embodiment 15. The system of any of embodiments 1-14, wherein the gas and water permeable material that is substantially impermeable to microorganisms is permeable to oxygen.

Embodiment 16. The system of any of embodiments 1-5, wherein the system is made from a pliable material.

Embodiment 17. The system of embodiment 16, wherein the pliable material is a regenerated cellulose material.

Embodiment 18. They system of embodiment 16, wherein the pliable material is a polymeric material.

Embodiment 19. The system of embodiment 16, wherein the pliable material is a collagen based material.

Embodiment 20. The system of any of embodiments 1-19, wherein the system further comprises an absorbent material, paper, or a paper support.

Embodiment 21. The system of any of embodiments 1-20, wherein at least one end of the system can be opened and closed.

Embodiment 22. The system of embodiment 20 or 21, wherein the at least one end of the system can be opened and closed by folding.

Embodiment 23. The system of embodiment 20, 21 or 22, wherein the at least one end comprises a clip or zipper for opening and closing the system.

Embodiment 24. The system of embodiment 22 or 23, wherein the clip for opening and closing the system is a stainless steel tie clip.

Embodiment 25. A system for storage of personal hygiene products,
wherein the system comprises a cover for said personal hygiene products;
wherein said cover is made from a gas and water permeable material which contains pores smaller than one micrometer; and
wherein the gas and water permeable material is substantially impermeable to one or more microorganisms smaller than 5 microns.

Embodiment 26. The system of embodiment 25, wherein the gas and water permeable material is substantially impermeable to Streptococcus, Pseudomonas, Klebsiella, or Lactobacillus.

Embodiment 27. The system of embodiment 25 or 26, wherein the material is substantially impermeable to aerosolized microbes.

Embodiment 28. The system of any of embodiments 25 to 27, wherein the system promotes drying of enclosed products through wicking of moisture away from the enclosed products.

Embodiment 29. The system of embodiment 28, wherein the system has an interior surface and an exterior surface, and the system wicks moisture from the interior surface to the exterior surface.

Embodiment 30. The system of any of embodiments 25 to 29, wherein the gas and water permeable material is substantially impermeable to one or more viruses.

Embodiment 31. The system of any of embodiments 25 to 30, wherein the gas and water permeable material is a cellulose based material.

Embodiment 32. The system of embodiment 31, wherein the cellulose based material comprises a paper layer coated or impregnated with viscose.

Embodiment 33. The system of any of embodiments 25 to 32, wherein the system comprises a regenerated cellulose material.

Embodiment 34. The system of embodiment 33, wherein the system further comprises an absorbent material, paper, or a paper support.

Embodiment 35. The system of any of embodiments 25 to 34, wherein the cover further comprises an antimicrobial agent.

Embodiment 36. The system of any of embodiments 25 to 35, wherein the system comprises a tubular tooth brush cover that encases an entire tooth brush head and handle.

Embodiment 37. The system of any of embodiments 25 to 36, wherein at least one end of the system can be opened and closed, wherein the system has an interior that is sealed from microorganisms in the external environment when the end is closed.

Embodiment 38. The system of embodiment 37, wherein the at least one end of the system can be opened and closed by folding.

Embodiment 39. The system of embodiment 37, wherein the at least one end comprises a clip or zipper for opening and closing the system.

Embodiment 40. A method of preventing contamination of a personal hygiene product, comprising encasing the product in the system of any of embodiments 1 to 39, and closing an end of the system to the external environment.

Embodiment 41. The method of embodiment 40, wherein a source of prevented contamination is aerosolized microorganisms generated by flushing a toilet.

Embodiment 42. A method of producing a cover for a personal hygiene product, the method comprising:
extruding a material to form a layer that is permeable to gas and water permeable and substantially impermeable to one or more microorganisms; and
forming a closeable tube from the extruded layer.

Embodiment 43. The method of embodiment 42, wherein the tube is formed by cutting and sealing edges of the layer together.

Embodiment 44. The method of embodiment 42 or 43, further comprising forming a re-sealable closing mechanism on the tube.

### Example 1

Water and gas permeable materials of the present technology were tested for microorganism permeability. Specifically, penetration of listeria was tested in three different cellulose based materials of the present technology, each having pores of 1 micrometer or less.

Approximately 90 cm² of each material was tested by applying Listeria monocytogenes suspension (germ density 2.8×10⁰/ ml) to inoculate only one side of the material. 0.1 ml of Listeria monocytogenes suspension (germ density 2.8×10⁰/ml) was applied with a cotton swab every 10 minutes for one hour. After the one hour period of Listeria application, sterile cotton swabs were used to test the un-inoculated side of the material. This testing procedure was repeated after another 8 hour incubation at room temperature of 22-25° C. and a relative humidity of 65%.

### Results

Listeria monocytogenes was not detected on any swabs from the un-inoculated side of the five different tested materials. This indicates that Listeria monocytogenes did not penetrate any of the tested materials and, therefore, that the tested materials are not permeable to Listeria monocytogenes. This further demonstrates that the present materials block microorganisms having a size larger than the pores of the material.

We claim:

1. A system for storage of personal hygiene products,
wherein the system comprises a cover for said personal hygiene products;
wherein said cover is made from a gas and water permeable material which contains pores smaller than one micrometer; and
wherein the gas and water permeable material is substantially impermeable to one or more microorganisms smaller than 5 microns.

2. The system of claim 1, wherein the gas and water permeable material is substantially impermeable to Streptococcus, Pseudomonas, Klebsiella, or Lactobacillus.

3. The system of claim 1, wherein the material is substantially impermeable to aerosolized microbes.

4. The system of claim 1, wherein the system promotes drying of enclosed products through wicking of moisture away from the enclosed products.

5. The system of claim 4, wherein the system has an interior surface and an exterior surface, and the system wicks moisture from the interior surface to the exterior surface.

6. The system of claim 1, wherein the gas and water permeable material is substantially impermeable to one or more viruses.

7. The system of claim 1, wherein the gas and water permeable material is a cellulose based material.

8. The system of claim 7, wherein the cellulose based material comprises a paper layer coated or impregnated with viscose.

9. The system of claim 1, wherein the system comprises a regenerated cellulose material.

10. The system of claim 9, wherein the system further comprises an absorbent material, paper, or a paper support.

11. The system of claim 1, wherein the cover further comprises an antimicrobial agent.

12. The system of claim 1, wherein the system comprises a tubular tooth brush cover that encases an entire tooth brush head and handle.

13. The system of claim 1, wherein at least one end of the system can be opened and closed, wherein the system has an interior that is sealed from microorganisms in the external environment when the end is closed.

14. The system of claim 13, wherein the at least one end of the system can be opened and closed by folding.

15. The system of claim 13, wherein the at least one end comprises a clip or zipper for opening and closing the system.

16. A method of preventing contamination of a personal hygiene product, comprising encasing the product in the system of claim 1, and closing an end of the system to the external environment.

17. The method of claim 16, wherein a source of prevented contamination is aerosolized microorganisms generated by flushing a toilet.

18. A method of producing a cover for a personal hygiene product, the method comprising:
extruding a material to form a layer that is permeable to gas and water permeable and substantially impermeable to one or more microorganisms; and
forming a closeable tube from the extruded layer.

19. The method of claim 18, wherein the tube is formed by cutting and sealing edges of the layer together.

20. The method of claim 18, further comprising forming a re-sealable closing mechanism on the tube.
